(19) United States
(12) Patent Application Publication
(10) Pub. No.: US 2026/0332526 A1
(43) Pub. Date: Oct. 22, 2026

(54) AUTOMATED TRAFFIC MANAGEMENT WITH SECURE ROUTING FOR ENTERPRISE INTEGRATION

(71) Applicant: Charter Communications Operating, LLC, St. Louis, MO (US)

(72) Inventor: Vishal Chopade, Castle Pines, CO (US)

(73) Assignee: Charter Communications Operating, LLC, St. Louis, MO (US)

(21) Appl. No.: 19/184,687

(22) Filed: Apr. 21, 2025

(51) Int. Cl. H04L 45/851; H04L 45/02; H04W 36/18; H04W 40/10

(52) U.S. Cl. CPC H04L 45/851; H04L 45/08; H04W 36/18; H04W 40/10

(57) ABSTRACT

An access gateway for an internet service provider (ISP) network has at least one enterprise gateway, an internet gateway, at least one processor operative to cause the access gateway to perform a dynamic policy-based routing algorithm that routes (i) enterprise-associated traffic (e.g., mostly if not all IoT traffic) to and from at least one associated enterprise server via the at least one enterprise gateway and (ii) non-enterprise-associated traffic (e.g., mostly if not all non-IoT traffic) to and from the public internet via the internet gateway. The access gateway employs a machine-learning (ML) module that accesses an enterprise database to distinguish enterprise-associated traffic from non-enterprise-associated traffic based on (e.g., MAC) addresses of the wireless devices that generate the traffic.

### BACKGROUND

### Field of the Disclosure

The present disclosure relates to communication systems and, more specifically but not exclusively, to communication systems having both IoT and non-IoT devices.

### Description of the Related Art

This section introduces aspects that may help facilitate a better understanding of the disclosure. Accordingly, the statements of this section are to be read in this light and are not to be understood as admissions about what is prior art or what is not prior art.

With the rapid growth of diverse IoT (Internet of Things) devices connecting to ISP (Internet Service Provider) broadband networks through a variety of access technologies, enterprises require a robust mechanism to manage these devices and ensure secure data transmission. Existing solutions struggle to handle the large number of connected devices and their data paths, while also facing challenges in securely managing device traffic from ISP networks to enterprise servers, particularly in mixed-use environments.

Enterprises face numerous challenges in managing data traffic from IoT devices connected via ISP networks. These challenges include handling large volumes of devices with diverse connectivity requirements, such as different categories, priorities, data exchange frequencies, and quality of service expectations, while also ensuring data security and centralized control. Current solutions lack the necessary scalability and security to effectively manage and segregate data traffic, particularly in environments with multiple device types connected to an ISP access point.

FIG. 1 is a block diagram of a portion of a conventional communication system 100 having an IoT device 112. As shown in FIG. 1, the ISP network 110 includes the IoT device 112, a connected device (e.g., tablet or cell phone) 114, an ISP access point 116, and an access gateway 118. When direct internet connectivity 120 is not available to the ISP network 110, then, in order for the IoT device 112 to access an associated enterprise server 124 or the public internet 126, the IoT device 112 communicates with the connected device 114, which communicates with the access point 116, which communicates with the access gateway 118, which communicates with the enterprise server 124 or the public internet 126 via a third-party VPN (virtual private network) server 122.

### SUMMARY

Problems in the prior art are addressed in accordance with the principles of the present disclosure by providing a method that enables seamless connectivity, secure data transfer, and centralized device management for, for example, communication systems having both IoT and non-IoT devices.

In at least one embodiment of the present disclosure, an access gateway for an ISP network comprises at least one enterprise gateway, an internet gateway, and at least one processor operative to cause the access gateway to perform a dynamic policy-based routing algorithm that routes (i) enterprise-associated traffic (i.e., device traffic for a device that is associated with an enterprise server) to and from the associated enterprise server via the at least one enterprise gateway and (ii) other traffic (i.e., device traffic for a device that is not associated with an enterprise server) to and from a public internet via the internet gateway.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a portion of a conventional communication system;

FIG. 2 is a block diagram of a communication system according to certain embodiments of the present disclosure;

FIG. 3 is a message flow diagram representing the communications involved in a wireless device accessing a service endpoint of FIG. 2, according to certain embodiments of the disclosure.

FIG. 4 is a workflow diagram showing more details of the processing performed by the dynamic policy-based routing algorithm implemented by the access gateway (AG) of FIG. 2; and

FIG. 5 is a simplified hardware block diagram of an example node that can be used to implement the AG of FIG. 2.

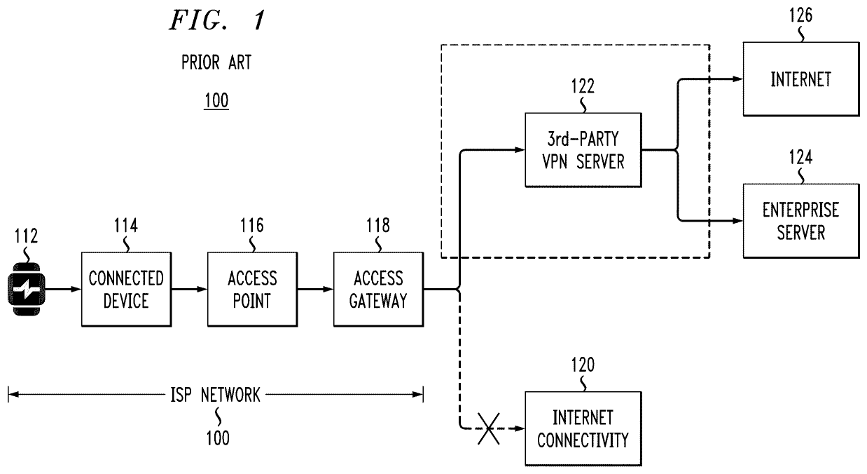

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

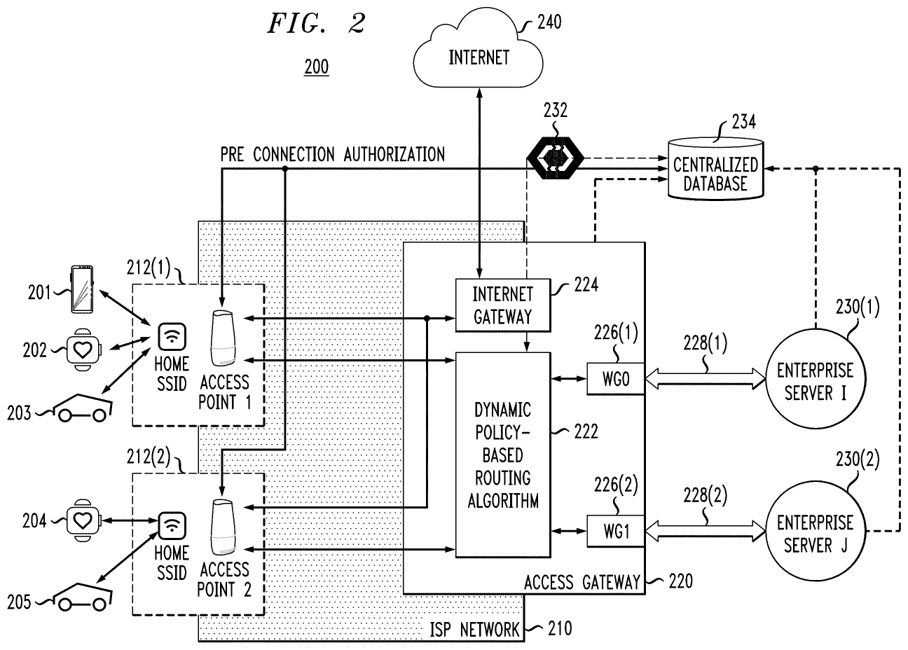

FIG. 2 is a block diagram of a communication system 200 according to certain embodiments of the present disclosure. At the heart of communication system 200 is an ISP network 210 that includes two ISP (e.g., WiFi) access points 212(1) and 212(2) and an ISP access gateway 220, which itself includes a processor-based, central, traffic management module 222 that implements a dynamic policy-based routing algorithm, an internet gateway 224 that provides access to the public internet 240, and two wireguard (WG) gateways 226(1) and 226(2) that provide respective access to two enterprise servers 230(1) and 230(2) via two WG VPNs 228(1) and 228(2). Those skilled in the art will understand that other communication systems of the present disclosure may have (i) ISP networks with any suitable number of access points 212 and (ii) access gateways 220 with any suitable number of WG gateways 226 for accessing corresponding enterprise servers 230 via corresponding WG gateways 226.

In addition, communication system 200 includes a machine learning (ML) module 232 and a centralized enterprise database 234, which are explained further below.

As shown in FIG. 2, cell phone 201, IoT device 202, and automobile 203 communicate wirelessly with access point 212(1) to selectively and independently access the public internet 240, enterprise server 230(1), and/or enterprise server 230(2) via ISP network 210. Similarly, IoT device 204 and automobile 205 communicate wirelessly with access point 212(2) to selectively and independently access the public internet 240, enterprise server 230(1), and/or enterprise server 230(2) via ISP network 210. In each of these instances, the module 222 routes the communications for the corresponding wireless device (e.g., cell phone, IoT device, automobile) to and from the appropriate service endpoint (e.g., public internet, enterprise server). Those skilled in the art will understand that, in general, an access point 212 can simultaneously support communications for any suitable number of wireless devices.

In some embodiments, module 222 separates and manages data traffic originating from IoT devices (such as, 202 and 204) within ISP network 210. Traffic from an IoT device intended for an associated enterprise server 230 is identified based on the IoT device's unique device identifier (e.g., MAC address) and securely routed through a corresponding WG VPN 228 to the associated enterprise server 230, while other (e.g., non-IoT) traffic is directed to the public internet 240.

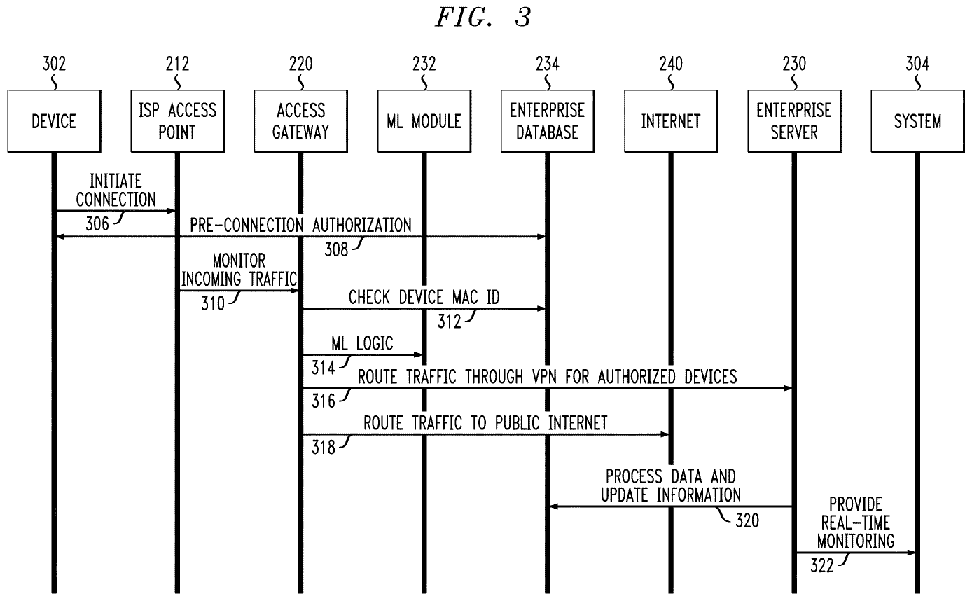

FIG. 3 is a message flow diagram representing the communications involved in a wireless device 302 (e.g., any of devices 201-205 of FIG. 2) accessing a service endpoint (e.g., endpoint 240, 230(1), or 230(2) of FIG. 2), according to certain embodiments of the disclosure.

In step 306, the device 302 initiates a connection to the corresponding ISP access point 212, beginning the process of establishing connectivity.

In step 308, a pre-connection authorization is performed with the enterprise database 234 via the access gateway 220 to verify the legitimacy of the incoming connection request.

In step 310, the access gateway 220 monitors incoming traffic from the ISP access point 212 and intercepts the incoming connection request. The access gateway 220 can function as either a distributed or centralized network gateway, designed to be cloud-native and capable of scaling flexibly according to traffic demands. The access gateway 220 plays a crucial role in authenticating and authorizing wireless devices before establishing data connectivity, ensuring secure data exchange.

In step 312, the access gateway 220 verifies the MAC ID of the device 302. For IoT devices, the access gateway 220 verifies the MAC ID by checking against records stored in the enterprise database 234, which provides real-time information regarding authorized IoT devices. The ML module 232, whether implemented separately (e.g., in the cloud, as in FIG. 2) or integrated within the access gateway 220, checks the IoT device's details (e.g., MAC address, device type) against the enterprise database 234 to speed up the approval or denial process based on historical data. The ML module 232 learns over time, making future authorizations faster and more accurate. If the ML module 232 approves the IoT device, then authorization is granted and the IoT device can then connect via its secondary SSID (described further below). Once authorized, the IoT device begins transmitting data to the access point 212, which forwards the data to the access gateway 220 for further processing. The access gateway 220 analyzes inbound data packets to identify the associated enterprise server 230 based on MAC ID or device endpoint information. For non-IoT devices, the access gateway 220 might not be able to verify the device's MAC ID.

In step 314, the access gateway 220 accesses the ML module 232 to assist in the routing decision-making process. To ensure efficient data transfer for IoT devices, the dynamic policy-based routing algorithm 222 implemented by the access gateway 220 incorporates several factors into its decision-making process. These factors include an IoT device's location, quality of service (such as device category, priority, and latency), allowable IP (Internet Protocol) subnet address allocation for the target location, and data insights derived from the AI/ML-enabled cloud-based enterprise database 234. This helps to optimize the data management path towards the associated enterprise servers 230.

In step 316 and 318, depending on the routing decision of step 314, the access gateway 220 routes traffic from the device 302 to either an associated enterprise server 230 (step 316, e.g., for IoT devices) or the public internet 240 (step 318, e.g., for non-IoT devices). The access gateway 220 implements dynamic, policy-based routing of traffic, ensuring that authorized IoT devices are securely connected to the associated enterprise servers 230 through corresponding WG VPNs 228, while other (e.g., non-IoT) devices access the public internet 240 via the internet gateway 224.

For IoT traffic that reaches an associated enterprise server 230, in step 320, the enterprise server 230 processes the incoming IoT data, updates the relevant information in the enterprise database 234, and provides real-time monitoring of the IoT device 302 and other connected devices, if any. The enterprise database 234 is continually updated with MAC IDs and access permissions of authorized IoT devices. IoT devices that are identified as authorized have their MAC IDs added to the enterprise database 234, which allows secure routing through a corresponding VPN 228 to an associated enterprise server 230.

In step 322, the enterprise server 230 enables system 304, e.g., an enterprise control computer, to monitor the operations of the enterprise server 230 and/or make changes to those operations.

Referring again to FIG. 2, an access point 212 may have a primary service set identifier (SSID) intended for regular usage (e.g., for laptops, smartphones) that offers a secure and user-friendly connection for personal devices. If there is only one SSID supporting IoT traffic, then the ML module 232 will verify the manufacturer and MAC ID to tag an IoT device to its associated enterprise server 230 and save that information as a secondary SSID for future use in automatically onboarding IoT devices. As soon as an IoT device recognizes the secondary SSID, the device sends an authorization request to an access point 212 to connect. When a compatible device detects this SSID, the ML module 232 prompts an authorization workflow to ensure that only approved IoT devices can join. A compatible device is a device, such as a smart IoT device, that is authorized by an associated enterprise to be connected to an access point 212 without manually entering a password.

FIG. 4 is a workflow diagram showing more details of the processing performed by the dynamic policy-based routing algorithm 222 implemented by the access gateway 220 of FIG. 2 for an IoT device 302 of FIG. 3. In step 402, after the IoT device 302 initiates a connection request, the access gateway 220 uses the ML module 232 to verify the IoT device 302 and its MAC address, where the ML module 232 may use the centralized enterprise database 234 to confirm legitimacy and trustworthiness.

After the IoT device 302 is verified, in step 404, the access gateway 220 requests server details and status from the ML module 232, which consults the enterprise database 234 to provide information (e.g., availability, health, risk status) about the IoT device's associated enterprise server 230.

In step 406, the access gateway 220 checks its local cache 408 to see if a point-to-point (PoP) WG VPN 228 is already established for this device-server combination. If not, then, in step 410, the access gateway 220 initiates creating the PoP WG VPN connection for the IoT device 302. This may be an open-source VPN setup that allows secure communication between the IoT device 302 and the associated enterprise server 230. If the cache 408 indicates, in step 406, that the WG VPN 228 is active, then, in step 412, the access gateway 220 proceeds directly to connect the IoT device 302 to the associated enterprise server 230.

After routing decisions are made, the access gateway 220 automatically initiates the open-source WG VPN 228 to create a secure peer-to-peer connection between the access gateway 220 and the associated enterprise server 230. All data over the WG VPN 228 is preferably encrypted, keeping sensitive information safe from unauthorized access.

After establishing a secure VPN tunnel, in step 414, the access gateway 220 forwards the request or data to the associated enterprise server 230 for further processing. The access gateway 220 continues with whatever business logic or data exchange is required over this secure channel.

Throughout the process, the ML module 232 communicates with the enterprise database 234 to keep details about the IoT device 302 and its associated enterprise server 230 up to date. This ensures that future connections can be quickly verified and established based on current policies, device reputation, and server status. The ML module 232 continually updates its models based on newly authorized IoT devices 302 and network behavior, resulting in faster authorizations and improved routing decisions. Historical data about device types, usage patterns, and performance metrics inform the ML module 232, which can proactively optimize network policies and security.

Integrating machine learning (e.g., via a supervised learning model) into the access gateway 220 via ML module 232 can significantly enhance security and efficiency by providing some or all of the following features:
Authorization and Onboarding: The ML module 232 verifies IoT devices 302 using MAC addresses and the centralized enterprise database 234, learning from historical authorization requests for faster, more-reliable authorizations. This reduces manual effort, updates the enterprise database 234 automatically, and ensures rogue devices are detected and denied access promptly.
Dynamic Routing and Traffic Optimization: The ML module 232 analyzes real-time data to optimize traffic flow by considering latency, device priority, and network load. The ML module 232 also predicts peak traffic times, enabling proactive load balancing. The ML module 232 minimizes network congestion, ensures better quality of service (QoS), and incorporates energy-efficient routing by identifying optimal paths.
Device Behavior Profiling and Threat Detection: The ML module 232 builds behavioral profiles for IoT devices 302 based on historical data, enabling early detection of anomalies and compromised devices. Advanced models such as deep learning can identify sophisticated cyberattacks like distributed denial-of-service (DDoS), phishing attempts, and unauthorized data exfiltration. This enhances network security and enforces stricter policies on suspicious devices.
Geofencing and Context-Aware Routing: By integrating geofencing, the ML module 232 ensures IoT devices 302 operate only within authorized physical locations, preventing unauthorized access. Additionally, context-aware ML models consider factors like weather, time, and criticality of devices to optimize routing, ensuring adaptability to changing conditions.
Predictive Maintenance: The ML module 232 analyzes IoT device health metrics to anticipate failures before they occur, reducing downtime and improving the reliability and lifespan of IoT devices 302. This proactive approach helps maintain smooth network operations.
Federated Learning for Privacy: Federated learning enables the ML module 232's models to train on distributed data without transferring the data to a central server, ensuring data privacy and regulatory compliance. This approach also reduces bandwidth usage during training.
Energy-Efficient Traffic Steering: The ML module 232 identifies energy consumption patterns and optimizes routing decisions accordingly, minimizing energy costs while supporting enterprise sustainability goals.
Real-Time QoS Adjustments: The ML module 232 dynamically adjusts QoS policies based on application requirements, prioritizing critical traffic (e.g., health devices) over less-critical traffic. This ensures IoT devices 302 meet necessary bandwidth and latency requirements, improving user experience and reducing interruptions.
Advanced Network Simulation: The ML module 232 can simulate network scenarios to test and optimize policies before deployment. This reduces the risk of unforeseen issues in live environments and ensures a smoother implementation.

In some implementations, the access gateway 220 and/or the ML module 232 enable IoT devices to roam seamlessly (i.e., maintaining ongoing communications) between different wireless networks. For example, IoT device 202 of FIG. 2 may physically move from being connected to access point 212(1) of one WiFi network to being connected to access point 212(2) of a different WiFi network while continuously communicating via the access gateway 220 with the IoT device's associated enterprise server 230. Note that, if access point 212(2) supports a different set of services from access point 212(1), then the wireless gateway 220 will limit the services provided to IoT device 202, as appropriate, when its wireless connection transitions from access point 212(1) to access point 212(2).

In some implementations, the access gateway 220 and/or the ML module 232 identify energy consumption patterns of IoT devices and optimize routing decisions for the IoT devices accordingly, thereby minimizing energy costs while supporting enterprise sustainability goals.

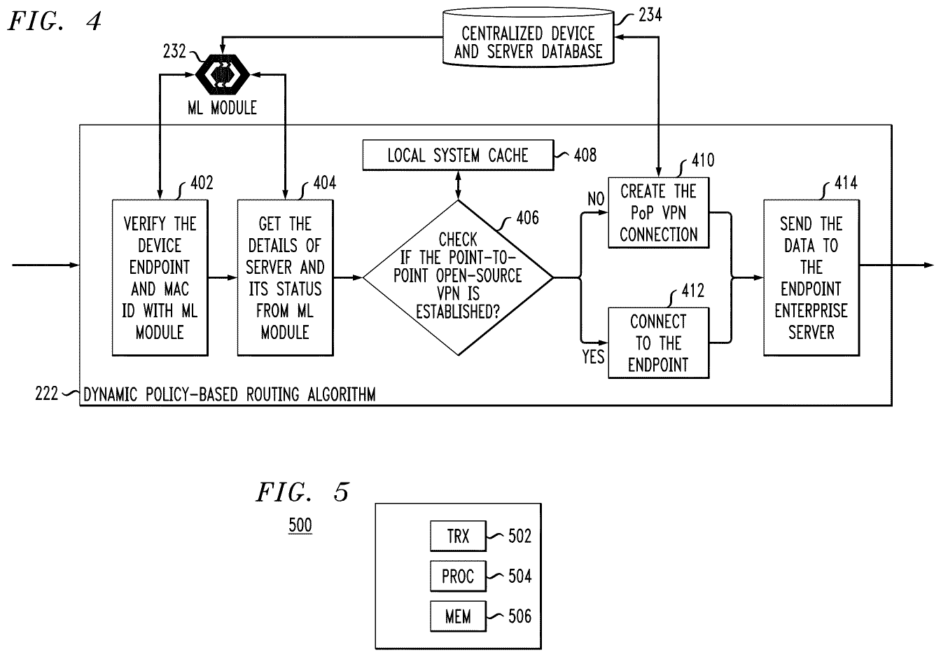

FIG. 5 is a simplified hardware block diagram of an example node 500 that can be used to implement the access gateway 220 of FIG. 2. As shown in FIG. 5, the node 500 includes (i) communication hardware (e.g., wireless, wireline, and/or optical transceivers (TRX)) 502 that supports communications with other nodes, (ii) one or more processors (e.g., CPU and/or GPU microprocessors) 504 that control the operations of the node 500 and/or process data within the node 500, and (iii) one or more memories (e.g., RAM, ROM) 506 that store code executed by the processors 504 and/or data generated and/or received by the node 500.

The present disclosure has been described in the context of an access gateway 220 that routes all IoT device traffic to and from associated enterprise servers 230 and all non-IoT device traffic to and from the public internet 240. Those skilled in the art will understand that alternative access gateways may implement policy-based routing (PBR) using the device's MAC address or local IP assigned to the device by the access point to route some of the IoT device traffic to and from the public internet 240 and/or some of the non-IoT device traffic to and from one or more enterprise servers 230.

In general, whether a device (e.g., 201-205) is an IoT device or a non-IoT device, when the device communicates with the access gateway 220, the access gateway 220 queries the centralized enterprise database 234 to determine whether the device is associated with an enterprise server 230. If so, then the access gateway 220 routes the communication from the device to that associated enterprise server 230. If not, then the access gateway 220 routes the communication from the device to the Internet 240. In real-world applications, few if any non-IoT devices and most if not all IoT devices may be associated with enterprise servers 230, but the access gateway 220 will route device traffic based on whether or not the device is associated with an enterprise server 230, not whether the device is an IoT device or a non-IoT device.

As used herein, the term “IoT device” refers to a wireless device that accesses an access point of a suitable ISP network where the IoT device can connect to the Internet and can fetch and/or store data on the cloud for users to see.

In certain embodiments, the present disclosure is an access gateway (e.g., 220) for an internet service provider (ISP) network (e.g., 210). The access gateway comprises at least one enterprise gateway (e.g., 226); an internet gateway (e.g., 224); and at least one processor operative to cause the access gateway to perform a dynamic policy-based routing algorithm that routes (i) enterprise-associated traffic associated with an interprise server to and from the associated enterprise server (e.g., 230) via the at least one enterprise gateway and (ii) non-enterprise-associated traffic not associated with an enterprise server to and from a public internet (e.g., 240) via the internet gateway.

In at least some of the above embodiments, the access gateway is configured to employ a machine-learning (ML) module (e.g., 232) to distinguish the enterprise-associated traffic from the non-enterprise-associated traffic.

In at least some of the above embodiments, the access gateway comprises the ML module.

In at least some of the above embodiments, the ML module accesses an enterprise database (e.g., 234) to distinguish the enterprise-associated traffic from the non-enterprise-associated traffic.

In at least some of the above embodiments, the access gateway and/or the access gateway are configured to identify energy consumption patterns of enterprise-associated devices and optimize routing decisions for the enterprise-associated devices accordingly.

In at least some of the above embodiments, the access gateway is configured to distinguish the enterprise-associated traffic from the non-enterprise-associated traffic based on an address of a wireless device (e.g., 201-205) that generated the traffic, wherein the access gateway communicates with the wireless device via an access point (e.g., 212) of the ISP network.

In at least some of the above embodiments, the access gateway is configured to enable an enterprise-associated device that is communicating via a first access point with an associated enterprise server to seamlessly transition to communicate via a second, different access point with the associated enterprise server.

In at least some of the above embodiments, the access gateway and/or the access gateway are configured to limit services provided to the enterprise-associated device via the second access point upon determining that the second access point supports a second set of services from a first set of services supported by the first assess point.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. An access gateway for an internet service provider (ISP) network, the access gateway comprising:
at least one enterprise gateway;
an internet gateway; and
at least one processor operative to cause the access gateway to perform a dynamic policy-based routing algorithm that routes (i) enterprise-associated traffic associated with an interprise server to and from the associated enterprise server via the at least one enterprise gateway and (ii) non-enterprise-associated traffic not associated with an enterprise server to and from a public internet via the internet gateway.

2. The access gateway of claim 1, wherein the access gateway is configured to employ a machine-learning (ML) module to distinguish the enterprise-associated traffic from the non-enterprise-associated traffic.

3. The access gateway of claim 2, wherein the access gateway comprises the ML module.

4. The access gateway of claim 3, wherein the ML module accesses an enterprise database to distinguish the enterprise-associated traffic from the non-enterprise-associated traffic.

5. The access gateway of claim 3, wherein the access gateway and/or the access gateway are configured to identify energy consumption patterns of enterprise-associated devices and optimize routing decisions for the enterprise-associated devices accordingly.

6. The access gateway of claim 2, wherein the access gateway is configured to distinguish the enterprise-associated traffic from the non-enterprise-associated traffic based on an address of a wireless device that generated the traffic, wherein the access gateway communicates with the wireless device via an access point of the ISP network.

7. The access gateway of claim 1, wherein the access gateway is configured to enable an enterprise-associated device that is communicating via a first access point with an associated enterprise server to seamlessly transition to communicate via a second, different access point with the associated enterprise server.

8. The access gateway of claim 7, wherein the access gateway and/or the access gateway are configured to limit services provided to the enterprise-associated device via the second access point upon determining that the second access point supports a second set of services from a first set of services supported by the first assess point.

9. A method for an access gateway for an internet service provider (ISP) network, the method comprising the access gateway performing a dynamic policy-based routing algorithm that routes (i) enterprise-associated traffic associated with an interprise server to and from the associated enterprise server via the at least one enterprise gateway and (ii) non-enterprise-associated traffic not associated with an enterprise server to and from a public internet via the internet gateway.

10. The method of claim 9, wherein the access gateway employs a machine-learning (ML) module to distinguish the enterprise-associated traffic from the non-enterprise-associated traffic.

11. The method of claim 10, wherein the ML module accesses an enterprise database to distinguish the enterprise-associated traffic from the non-enterprise-associated traffic.

12. The method of claim 10, wherein the access gateway and/or the access gateway identify energy consumption patterns of enterprise-associated devices and optimize routing decisions for the enterprise-associated devices accordingly.

13. The method of claim 10, wherein the access gateway distinguishes the enterprise-associated traffic from the non-enterprise-associated traffic based on an address of a wireless device that generated the traffic, wherein the access gateway communicates with the wireless device via an access point of the ISP network.

14. The method of claim 9, wherein the access gateway enables an enterprise-associated device that is communicating via a first access point with an associated enterprise server to seamlessly transition to communicate via a second, different access point with the associated enterprise server.

15. The method of claim 14, wherein the access gateway and/or the access gateway limit services provided to the non-enterprise-associated device via the second access point upon determining that the second access point supports a second set of services from a first set of services supported by the first assess point.
